(19) United States
(12) Patent Application Publication
(10) Pub. No.: US 2007/0162356 A1
(43) Pub. Date: Jul. 12, 2007

(54) Inventory mitigation collaboration and balancing system with organized and archivable communication means

(76) Inventors: Huy Nguyen, Cupertino, CA (US); Perpetua B. Tranlong, Cupertino, CA (US)

Correspondence Address: OFFICE OF DONALD GRANT KELLY;INTELLECTUAL ASSET MANAGEMENT ASSOCIATES, LLC, 515 KING STREET, SUITE 420, ALEXANDRIA, VA, 22314, US

(21) Appl. No.: 11/253,420

(22) Filed: Oct. 19, 2005

Related U.S. Application Data
(60) Provisional application No. 60/620,288, filed on Oct. 21, 2004.

(51) Int. Cl. G06Q 10/00

(52) U.S. Cl. 705/28

(57) ABSTRACT

A computer-implemented inventory management system is provided in which inventory data and inventory balancing transactions are conducted external to existing inventory databases and within which communication means are integrated and organized by means allowing for storage, archival and auditing. More particularly, the invention relates to an inventory managements system which can be operated in conjunction with and parallel to existing enterprise resource planning software, and within which data, transaction, communication and information can be updated dynamically and iteratively in responses to changes or as a result of prior balancing transactions, and within which data views and executable functions are presented to each user uniquely based on the user's uniquely-identified criteria, and within which communication data are tracked, stored and maintained dynamically and iteratively for future access, organization and archival.

### CROSS-REFERENCE TO RELATED APPLICATION

This application claims the benefit of prior U.S. Provisional Application Ser. No. 60/620,288 filed Oct. 21, 2004, which is hereby incorporated by reference. This application relates to the prior filing of patent application and disclosure entitled “Inventory mitigation and balancing system for dynamically and iteratively tracking, matching and exchanging inventory excess and shortage,” application Ser. No. 11/201,043, filed Aug. 10, 2005 (the “Prior Application”). The present application and disclosure incorporates by reference the application and disclosure in the Prior Application.

### STATEMENT REGARDING FEDERALLY SPONSORED RESEARCH OR DEVELOPMENT

Not applicable.

### FIELD OF THE INVENTION

The present invention relates generally to inventory management with automated inventory mitigation, collaboration and balancing solution and an organized archival system for referencing and auditing. More particularly, it pertains to automated and computerized methods and system creating an inventory depository and tracking to accomplish inventory mitigation, collaboration and balancing transactions and to collect, organize and archive all transaction-related records, communications, attachments and instant messaging chat sessions for referencing, planning, tracking and auditing purposes.

### BACKGROUND ART

This application incorporates by reference the background art disclosed in the Prior Application. This application further notes the following shortcomings of existing supply chain management (SCM) systems and business practices.

Current SCM systems and business practices experience significant difficulties in tracking, referencing and storing critical business information regarding inventory excess, shortage, exchange, contacts and related information once excess inventory has been traded or once shortage inventory has been fulfilled. Historical information regarding these transactions are often dispersed or not retained in a manner which would permit useful analysis, trend spotting, or future audits.

It is widespread business practice for business people to initiate, negotiate, and conclude business exchanges, including inventory mitigation transactions, through the use of email, chat sessions, and electronic transfer and sharing of data, files, purchase orders and other business communications. It is also an emerging business practice to use message boards to identify potential partners and business opportunities. Nevertheless, current SCM systems and business practices do not permit or require the systematic retention, organization, tracking and archival of these critical emails, chat sessions transcripts and attachments, and message board postings. Therefore, critical transaction details are lost, misplaced or simply forgotten.

Furthermore, even when individual business users attempts to collect and organize his own information, through popularly provided means such as creating and sorting through email folders and saving chat sessions on his own hard drive, there is no centralized automated means for the user to track all emails, chat sessions and attachments in one central locations that can be accessed by other users within the network or through the Web.

Another shortcoming of the lack of referencing, archiving and audit trail is that historical information are lost and cannot be gathered, analyzed, or used to implement future planning, optimal pricing levels, optimal inventory levels or other planning needs of the enterprise.

It will be appreciated by one skilled in the art that there are significant limitations to the current hodge podge of tools, products and systems in mitigating and balancing inventory excess and shortages, some of which are detailed above.

### SUMMARY AND DETAILED DESCRIPTION OF THE INVENTION

The present invention in its several disclosed embodiments in this application and the Prior Application combine best of breed in supply chain and inventory management systems with an innovative inventory mitigation system dependent on user-initiated exchange and trading of excess and shortage inventory across the single business enterprise or, optionally, across a plurality of business enterprise and its business partners including contract manufacturers and third party service providers.

An object of the present invention is to provide a method and system that allows for the deployment of the inventory mitigation and balancing business solution ideally suited for collaboration in a web hosting environment or web exchange environment or for the use of a business enterprise with multiple network participants by allowing for the participants to communicate using a variety of methods including the sharing of files through the ability to send emails, file attachments to emails, recordable instant messaging chat sessions and posts to message boards.

A further object of the present invention is to provide a method and system that allows for the deployment of the inventory mitigation and balancing business solution ideally suited for collect, organize and archive all transaction-related records, communications, attachments and instant messaging chat sessions for referencing, planning, tracking and auditing purposes.

Still another object of the present invention is to provide a method and system which can dynamically and iterative update and populate throughout the system newly arrived transaction information including new emails, attachments, messages, message boards, user availability on the instant messaging systems, and other data and business solutions within the system.

A further object of the present invention is that the users can have communications functionalities and features and the ability to organize and archive information superior to those currently provided by existing SCM technology with minimum coding and recoding, thereby allowing a wide range of users to use and participate in the present invention, including users who are not necessarily skilled in the art.

Still other objects, features and advantages of the present invention will be readily apparent in one skilled in the art from the following description. The drawings and descriptions are to be regarded as illustrative in natures, and are not to be restrictive. What is intended to be protected by Letters Patent is as set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

FIG. 1 and attached Glossary of Terms together form a block diagram of the preferred embodiment Inventory Mitigation System (IMS) in accordance with the present invention as disclosed in the Prior Application and in this application, with certain disclosures simplified from the Prior Application.

FIG. 2 is an example workflow which could be implemented in the IMS shown in FIG. 1 for the operational activities of Users using the software routine supported by the IMS shown in FIG. 1 to create and send email, attachments, chat sessions and message board postings.

FIG. 3 is a representative flowchart of the linkage and tracking of Communications using the software routine supported by the IMS shown in FIG. 1 to assign, track, and archive Communications created during the use of the IMS shown in FIG. 1.

### DETAILED DESCRIPTION OF THE INVENTION

In the following description of the invention, the description and disclosure made in the Prior Application is incorporated by reference and further reference is made to the accompanying drawings which form a part hereof, and in which is shown by way of illustration the specific embodiment in which the invention may be practiced. It is to be understood that other embodiments may be utilized as structural changes may be made without departing from the scope of the present invention. The following description omits certain software modules more fully described in the Prior Application where such software modules are not necessary to the description of the claims made in this application.

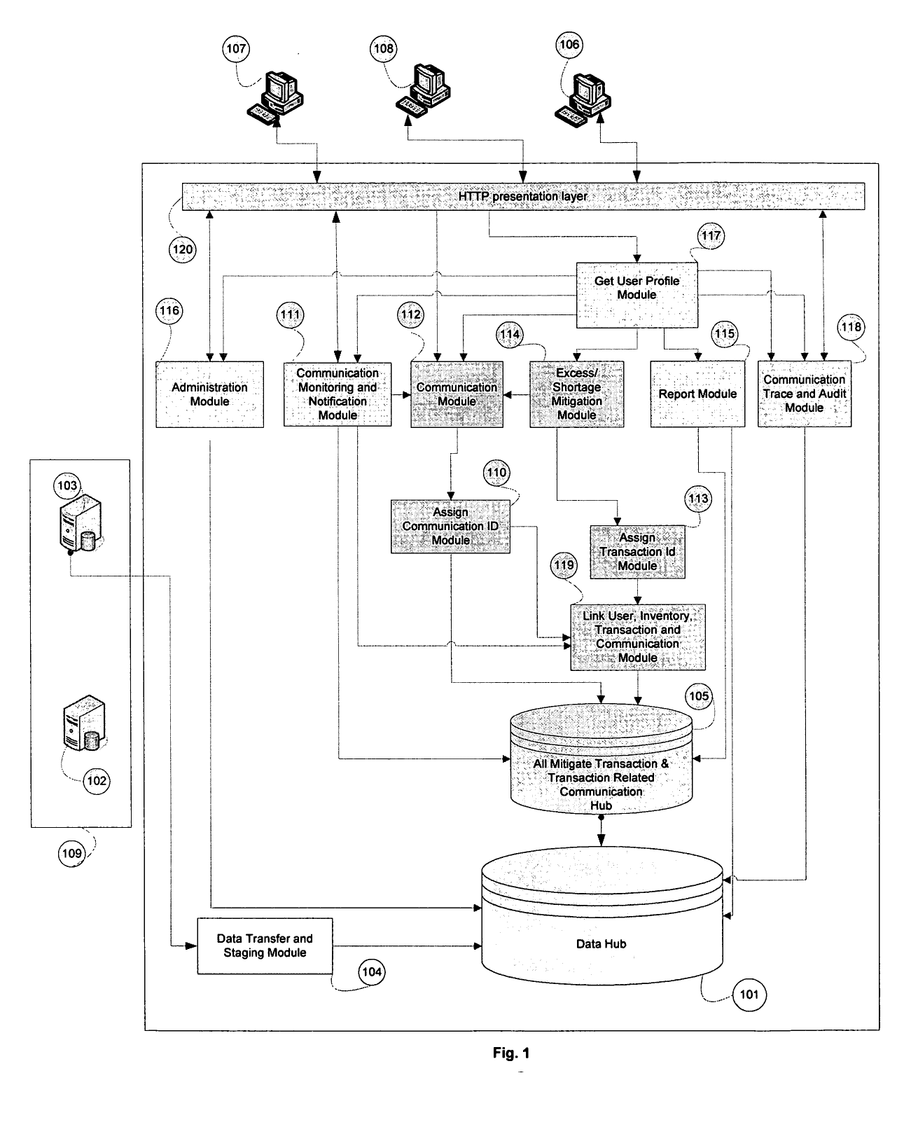

Referring now to FIG. 1 and its accompanying Glossary of Terms, a block diagram of the preferred embodiment IMS system 100 in accordance with the present invention is shown.

The IMS 100 is a client/server web-based product consists of the following:

1. The Information System (IS) department of the business enterprise establishes a host-operated inventory data hub 101 (herein called Hub or Data Hub), consisting of an information management system or multiple software components running as a single system hosted on a computer server or a plurality of computer servers or a distributed computer system having information processing and storage capabilities and electronic communication connection into the Internet or Intranet such as T-1 or T-3 connection. The computer servers or distributed computer system can be physically close together and connected by a local network, or geographically distant and connected by a wide area network, and can comprise any number of possible configurations—mainframes, personal computers, workstations, minicomputers, etc, with the goal of making such a network act as a single computer.

2. Each inventory location (herein called Warehouse) 102 103 within the enterprise is assigned a unique identifier within the Hub. This identifier is linked to all inventory located at the specified Warehouse and linked to all users accessing the Hub from the specified Warehouse. Each Warehouse can comprise of a single Contract Manufacturer (CM) or a divisions or subdivision of a CM or a physical warehouse location of the business enterprise and so forth.

3. Existing inventory data from selected or all of the Warehouses across the enterprise are initially duplicated on the Hub using existing data transfer and staging programs 104.

4. Each user (herein called User) 107 108 accessing the Hub is assigned a unique identifier (log-in ID) and password utilized by the Hub to identify each upon their log in into the Hub. Each User is further identified as linked to a base Warehouse and granted limited electronic access to the Hub to carry out specified approved activities, representative illustrations of which are set out below. Each User is further assigned to an IS-defined community 109 (herein Community) which consists of one or more Warehouses. A Community defines the maximum portion of the Hub to which the specified User has access. For illustrative purpose, a User assigned to a Los Angeles warehouse may be assigned to the Pacific Coast Community, consisting of Warehouses located only in California, Washington, and Oregon.

5. Users which are allowed certain administrative functions such as management of User base, Communities and Sub-Communities and communication software routines are referred to as Administrators 106. Administrators are granted administrator access to the Hub to carry out specified administrative activities, including communication tracing and auditing 119. Administrators are assigned to a specified Community which consists of one or more Warehouses.

6. The Hub maintains primary responsibility as a depositary for inventory information and for database manipulation. Within the Hub, data relating to all mitigation transactions and communications are maintained in the All Mitigate Transactions & Transaction-related Communications Hub 105. The Hub operates in a database format in which each inventory item and communication item is maintained as one of a plurality of records and assigned a unique identifier for locating, tracking and processing purpose. Each record is formatted to a base template that has a plurality of fields wherein each field is intended to contain a specific type of information about the inventory item. Similarly, the Hub maintains each User record as one of a plurality of records, each formatted to a base template that has a plurality of fields wherein each filed is intended to contain a specific type of information about the User and the approved activities of the User.

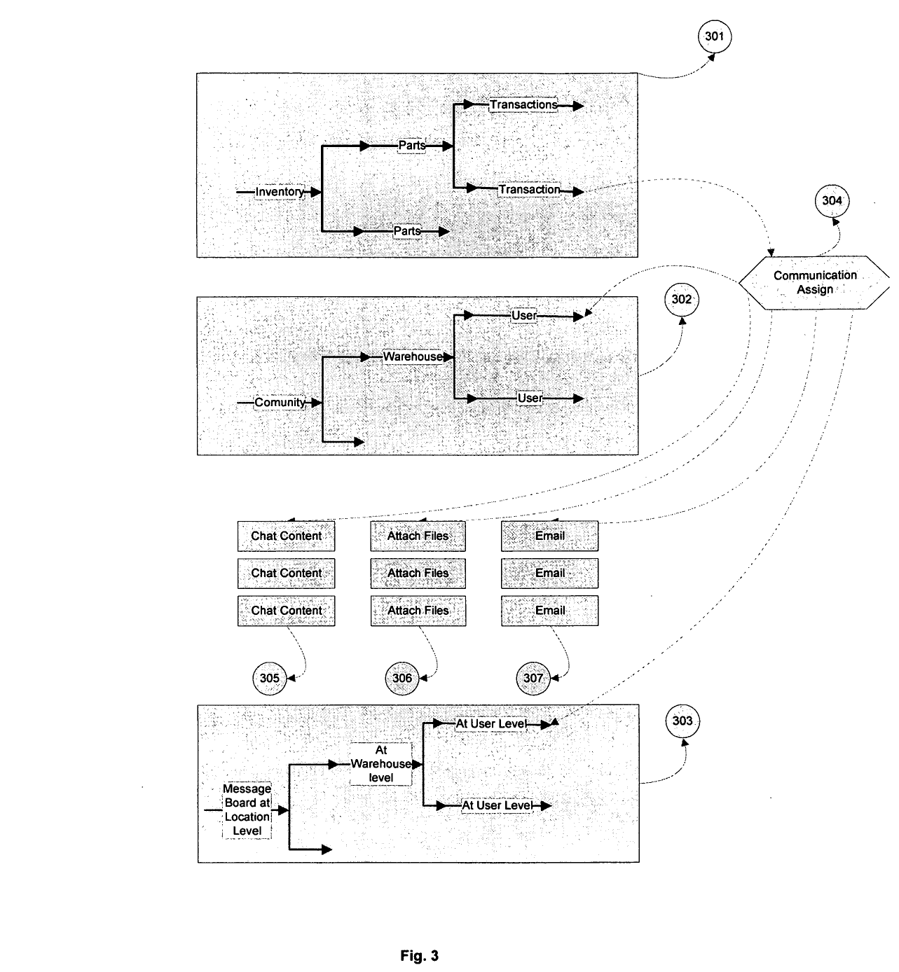

7. The Hub maintains software programs and software routine modules 104 106 111 through 120 inclusive of a software presentation layer 120 to assist the Administrators and the Users in managing the excess/shortage mitigation transactions and all related communications, updating dynamically and iteratively the communication data, tracing and auditing communications and perform other communication-related monitoring and linking. Representative and minimum required software routines with respect to mitigation functions are set forth in the Prior Application, inclusive of a software routine to assign a unique transaction identification to each excess/shortage mitigation transaction 113, and other software routines for excess/shortage mitigation 114. Representative and minimum required software routines with respect to communication functions are as follows:
A software routine which assigns a unique identifier to each item of communication, including each item of email, chat session, attachment and message board posting 110. A Communication may include any combination of email, instant messaging chat session, postings to message boards, attachments of files or data including software applications (e.g., Excel spreadsheet or Word documents), scanned pictures (e.g., purchase order or purchase order requirements), audio clips, video clips and other files and data (each email, chat session, attachment and other communication is referred to separately as Communication and collectively as Communications).
A software routine which monitors for new Communications and displays all Communications 112 for a specified User or Administrator or for a specified transaction or message board by tracking and retrieving new Communications from the All Mitigate Transactions and Transaction-related Communication Hub 105. Communications are marked are optionally flagged as “new”, “read”, “reply needed”, “reply sent”, or other flags indicating status or actions needed. Communications are automatically and iteratively linked and tracked for organization, archival and auditing purposes in accordance with criteria established by the Hub and maintained in the Link User, Inventory, Transaction and Communication Module 119, a representative example of which is set out in FIG. 3.
One or more software routines which provides for multiple communication means among the Users and Administrators, representative means including email messages, file attachments, chats, message boards, audio, pictures or videoclips and other files and data 112.
One or more software routines which provides for the collection and generation of Communication reports for a specified User or Administrator based on User Profile Module, of all allowable data and communications from the Hub 115.
One or more software routines which provides for the tracing Communications 118 for auditing, archival and retrieval purposes.
One or more software routines which provides for the linking of Communications to specified transactions, users, administrator, message board, Warehouses 119. A representative flowchart of possible linkage is set forth in FIG. 3.
Other software routines may be identified and applied at the Hub to facilitate and support the communication means, to enhance the linking capabilities, to enhance the reporting and auditing capabilities, to improve viewing ease for Users, or for other corporate needs as identified.

Software routines described herein are intended to be within the scope of the invention and optionally described in more details in further applications in compliance with patent laws and regulations.

8. Because each User or Administrator is uniquely identified, the Hub is able to present a unique log-in page (View page) to each User upon each log-in of the User in the presentation layer 120 (FIG. 1). Similarly, the Hub is able to limit each User to specific approved activities (Approved Activities) based on predetermined criteria. Upon User log-in, the Hub validates the User's or Administrator's name and password and retrieves the unique log-in page for the User, including a list of Community(ies) to which the User belongs through software routines to get the User's Profile 117 or Administrator's Profile 116. The User must select one Community (if he belongs to more than one Community) for each log-in session. Upon the User's selection of a Community, the Hub then retrieve all accessible locations for the selected Community for the specified User, all accessible data views for the specified User, and all executable internal and external functions for the specified User. The User can then select from among the locations, data views and executable internal and external functions available to him through specified administrative software routines.

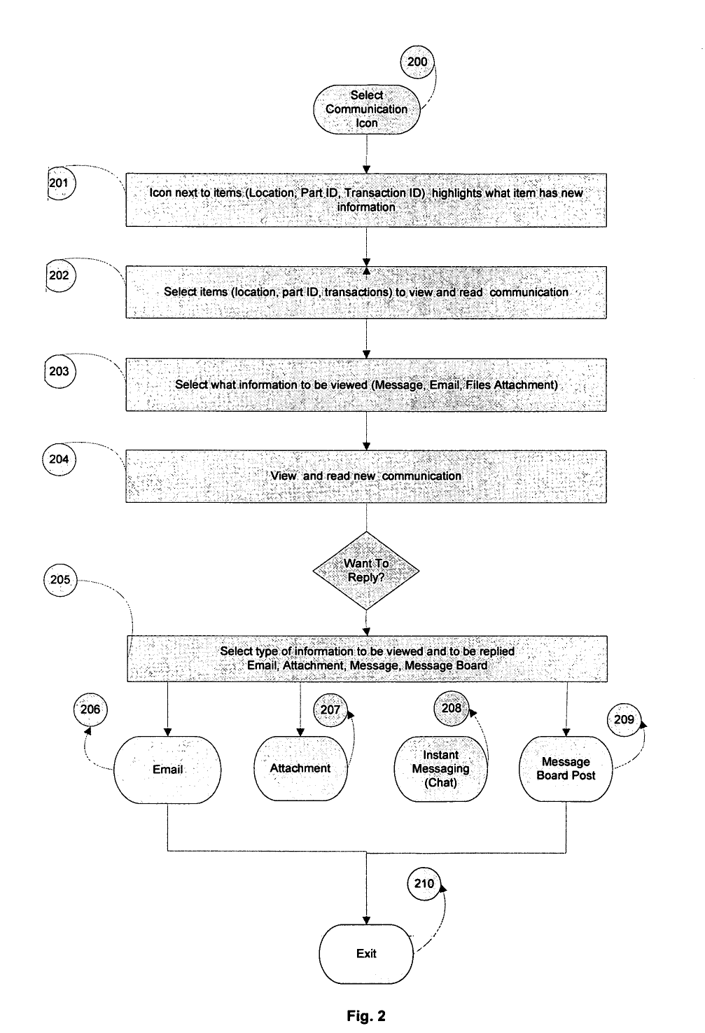

Referring now to FIG. 2, an example workflow which could be implemented in the IMS shown in FIG. 1 is shown for the operational activities of Users using the communication software routines supported by the IMS shown in FIG. 1 to view, reply to, initiate and otherwise act on Communication:
In accessing the Hub, a specified User has access to multiple view pages, including item view, part ID view, transaction views, Warehouse view, and other views. In each of these viewpages, software routines provides for an easily accessible communication icon for the User to view, read, track and initiate Communication 200. A separate icon next to each item (location, part ID, transaction ID) highlights what item has new Communications 201;
Once the User has selected the Communication icon, the software reverts to a default Communication track or optionally prompts the User to select the track in which the User is interested in reviewing the Communication 202. The default track is determined by the viewpage at which the User selects the Communication icon: for example, if the User was viewing a particular excess/shortage transaction, clicking on the Communication icon would permit the User to view all Communications related to that transaction, and the User has the option of choosing another track to view Communications.
The User then select the Communication to be viewed 203, and clicks on the Communication to view and read the Communication 204.
If the User wants to submit a new Communication, either in reply to a message or to initiate a new Communication, the User needs to select 205 what new Communication or information he wishes to submit (email 206, attachment 208, chat 205, message board post 209, etc.).
At any time, the User may select the exit function 210 to exit the Communication track.

9. Referring now to FIG. 3, a flowchart is shown of a representative linkage and tracking of Communication using the software routine supported by the IMS shown in FIG. 1 to assign, track, and archive Communications created during the use of the IMS shown in FIG. 1. The linkage and assignment of Communications to the specified tracks may be determined by default by the Hub and optionally changed by the Administrator to reflect the business needs of the enterprise. The representative linkages shows as follows:
Each Warehouse is uniquely identified, each type of inventory part is uniquely identified, and each excess/shortage mitigation transaction is uniquely identified 301;
Each Community consists of multiple Warehouses and each User and Administrator belonging to a Community is uniquely identified 302;
The Administrator and optionally certain Users may set up general or specific message boards relating to general matters or specific inventory mitigation issues, and Users may be invited or assigned or elected to join in such message boards 303;
Each Communication generated (whether chat 305, attachment 306, email 307 or message board post) is assigned its own unique identification 304 with markers assigning the Communication to the excess/shortage transaction if the Communication is generated as a result of the User clicking on the Communication icon using the viewpage specific to that transaction, and also to the Users involved in the excess/shortage transaction.
Each Communication generated (whether chat 305, attachment 306, email 307 or message board post) is assigned its own unique identification with markers assigning the Communication to the part's unique identification if the Communication is generated as a result of the User clicking on the Communication icon using the viewpage specific to that part, and also to the Users involved in the excess/shortage transaction.
Each Communication generated (whether chat 305, attachment 306, email 307 or message board post) is assigned its own unique identification with markers assigning the Communication to the message board's unique identification if the Communication is generated as a result of the User clicking on the Communication icon using the viewpage specific to that message board, and also to all Users who participate in such message board.

The foregoing description of the IMS including email, chat and attachment and message board postings functions with organized archival system for referencing and auditing and the exemplary embodiment of the invention have been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto. It will be appreciated by one skilled in the art that this system can be configured utilizing modern application server, XML or .NET technology provided by software vendors like IBM, Microsoft, Oracle etc. without departing from the scope and spirit of the present invention.

What is claimed is:

1. A computer-implemented method for dynamicall and iteratively tracking matching and exchanging inventory excess and shortage including email, chat and attachments and message board posting functions with organized archival system for referencing and auditing comprising the steps of:
specifying an inventory hub consisting of an information management system and storage means;
specifying a plurality of Warehouse inventory data sources containing inventory data;
specifying a plurality of users of inventory data for inventory viewing and balancing purposes;
specifying at least one administrator for management of data and software routines;
constructing a plurality of software routines with coupling means to the inventory data source and users and administrator and containing at least one software routine to do data transfer, filtering and validation, one software routine to set up, register and manager users, administrators and Warehouses accessing the inventory hub, one software routine to extract, transfer and load inventory data, one software routine to search and match inventory for balancing transaction, one software routine for search result presentation and data presentation and display, one software routine for transaction execution and tracking, one software routine for updating change to the inventory data, one software routine for communication and one software routine for administrative functions;
with respect to excess/shortage mitigation transaction, loading of inventory data based to said inventory hub, searching and matching inventory excess and shortage, presenting search results, executing and tracking inventory balancing transactions,
executing and tracking changes to user base and inventory data, and updating changes to said inventory hub and transmitting changes to initial inventory data sources automatically and iteratively by software without human intervention;
with respect to communications means within the execution of the computer implemented method,
assigning to each communication (email, instant messaging chat session, message board postings, attachments or any other recognized means of electronic communications) a unique identifier and further linking such communication to a transaction, part, or message board and secondarily to users, administrators, and warehouses;
monitoring, retrieving and displaying all communications to a defined User based on predetermined criteria;
collecting and generating reports for a specified User or Administrator based on the user profile or administrator profile, such reports to cover the scope of all allowable communication as determined by the user profile or administrator profile;
maintaining and archiving all communications for a predetermined period of time based on system-determined or Administrator-determined criteria;

2. The computer implemented method of claim 1, where the software routine to monitor communications include at least one routine to retrieve and display new communications dynamically and iteratively without further human intervention on a schedule or optionally as triggered by user-defined criteria;

3. The computer implemented method of claim 1, where the software routine to monitor communications include at least one routine to flag communications as “new,” “read”, “reply needed”, “reply sent” or other flags indicating status or actions needed as determined by the Administrator or optionally by the User;

4. The computer implemented method of claim 1, where the software routine to search and display communications include at least one routine to allow users and administrators to define their own search and display criteria;

5. The computer-implemented method of claim 1, where the software routine for communication contains at least one reoutine to allow communication by means of electronic mail with attachments, which attachments can be files, executable software programs, pictures, audio clips, video clips, message board postings or any combination thereof;

6. The computer-implemented method of claim 1, where the software routine for communication contains at least one routine to allow instant user communication by means of electronic chat or electronic instant messaging;

7. The computer-implemented method of claim 1, where the software routine for communication contains at least one routine to allow users and administrators to create, maintain and participate in message boards to the extent allowable based on the user profile or administrator profile.
